(19) United States
(12) Patent Application Publication
(10) Pub. No.: US 2026/0076846 A1
(43) Pub. Date: Mar. 19, 2026

(54) PASSENGER SAFETY DEVICE, VEHICLE INCLUDING SAME AND METHOD OF OPERATING SAFETY DEVICE USING SAME

(71) Applicants: Hyundai Motor Company, Seoul (KR); Kia Corporation, Seoul (KR)

(72) Inventors: Hyuk Ho Kwon, Hwaseong-si (KR); Dae Hun Song, Hwaseong-si (KR)

(21) Appl. No.: 18/990,675

(22) Filed: Dec. 20, 2024

(30) Foreign Application Priority Data
Sep. 13, 2024 (KR) 10-2024-0125801

(51) Int. Cl. A61G 3/08

(52) U.S. Cl. CPC A61G 3/0808

(57) ABSTRACT

A passenger safety device can include a belt, a first restraint device being rotatable and having a first side and a second side connected to the belt, and a second restraint device connected to the first restraint device by the belt, where the second restraint device includes a roller rail, a roller connected to the roller rail and being drivable on the roller rail, and a belt support portion connected to the roller and capable of supporting the belt.

### CROSS-REFERENCE TO RELATED APPLICATIONS

This application claims the priority and benefit of Korean Patent Application No. 10-2024-0125801, filed on September 13, 2024, which application is hereby incorporated herein by reference in its entirety.

### TECHNICAL FIELD

The present disclosure relates to a passenger safety device capable of securing a passenger in a wheelchair.

### BACKGROUND

There are not many means of transportation that install equipment to restrain and secure the disabled who ride in wheelchairs when they board a vehicle or other means of transportation. Due to the characteristics of the disabled, the disabled may be more vulnerable to impacts caused by accidents than ordinary people, and therefore safety devices for the disabled are necessary.

The related art safety devices for wheelchair passengers have a belt support device secured to the passenger's head, which may cause inconvenience to the passenger during boarding or exiting a vehicle. In addition, because the device for securing the wheelchair is located on the side, it may be difficult to install another seat on the passenger's side.

### SUMMARY

The present disclosure relates to a passenger safety device capable of securing a passenger in a wheelchair when the passenger boards a vehicle, a vehicle including the same, and a method of operating the safety device using the same.

An embodiment of the present disclosure can provide a passenger safety device having a structure including a rotating first restraint device, a second restraint device including a roller rail, and a wheelchair docking device capable of fixing a wheelchair from the rear, thereby increasing passenger safety and space efficiency.

According to an embodiment of the present disclosure, a passenger safety device can include: a belt; a first restraint device being rotatable and having one side and the other side connected to the belt; and a second restraint device connected to the first restraint device by the belt, wherein the second restraint device includes a roller rail, a roller connected to the roller rail and being drivable on the roller rail, and a belt support portion connected to the roller and capable of supporting the belt.

The first restraint device may include: a rotary motor; a rotary arm connected to the rotary motor; a first support arm connected to one side of the rotary arm; and a second support arm connected to the other side of the rotary arm.

The first support arm and the second support arm may be connected by the belt.

The first support arm and the second support arm may vary in length.

The passenger safety device may further include: a retractor located below the first restraint device and the second restraint device, where the retractor may adjust a length of the belt, and the belt may extend from the retractor and pass through the belt support portion and the first support arm to the second support arm.

The roller may include a first roller and a second roller located behind the first roller, and the belt support portion may include: a first belt support arm connected to the first roller; a second belt support arm connected to the second roller; and a belt ring connected to the second belt support arm and supporting the belt.

The second restraint device may further include: a roller wire connected to the roller and supported by the roller rail; and a wire motor moving the roller wire.

The second restraint device may further include a stopper located on the first restraint device and capable of restricting movement of the second roller.

The first belt support arm and the second belt support arm may be connected by a joint, and the joint may change a support arm angle between the first belt support arm and the second belt support arm.

The second roller may include a rail coupling portion coupled to the roller rail, and the second roller may be restricted from moving on the roller rail by the rail coupling portion.

The second restraint device may further include a latch coupled to the first roller and restricting movement of the first roller.

The passenger safety device may further include: a floor rail; and a wheelchair docking device located below the first restraint device and the second restraint device and being movable on the floor rail.

The wheelchair docking device may include a hook-shaped wheelchair fixing hook.

According to an embodiment of the present disclosure, a method of operating a safety device can include: a wheelchair docking device driving operation of coupling, by a controller, a wheelchair docking device to a wheelchair and moving, by the controller, the wheelchair by the wheelchair docking device; a first restraint device driving operation of rotating, by the controller, a first restraint device; and a second restraint device driving operation of moving, by the controller, a belt support portion of a second restraint device, where in the second restraint device driving operation, the controller moves the belt support portion by moving the roller connected to a wire by a wire motor.

The first restraint device driving operation and the second restraint device driving operation may be performed simultaneously.

In the second restraint device driving operation, a position of a first roller may be fixed by coupling a latch to the first roller.

### BRIEF DESCRIPTION OF THE DRAWINGS

Features and advantages of example embodiments of the present disclosure can be more clearly understood from the following detailed description, taken in conjunction with the accompanying drawings, in which:

FIG. 1 is a perspective view schematically illustrating a vehicle according to an embodiment of the present disclosure;

FIG. 2 is a perspective view illustrating a passenger in a wheelchair and a passenger safety device according to an embodiment of the present disclosure;

FIG. 3 is a top view illustrating a passenger in a wheelchair and a passenger safety device according to an embodiment of the present disclosure;

FIG. 4 is a front view illustrating a passenger in a wheelchair and a passenger safety device according to an embodiment of the present disclosure;

FIG. 5 is a perspective view illustrating a first restraint device and a second restraint device according to an embodiment of the present disclosure;

FIG. 6 is a perspective view illustrating moving a first restraint device and a second restraint device according to an embodiment of the present disclosure;

FIG. 7 is a side view illustrating a second restraint device according to an embodiment of the present disclosure;

FIG. 8 is a side view illustrating a second restraint device according to an embodiment of the present disclosure;

FIG. 9 is a side view illustrating a second restraint device according to an embodiment of the present disclosure;

FIG. 10 is a perspective view illustrating a floor rail and a wheelchair docking device according to an embodiment of the present disclosure;

FIG. 11 is a top view illustrating a floor rail and a wheelchair docking device according to an embodiment of the present disclosure;

FIG. 12 is a flow chart illustrating a safety device operating method according to an embodiment of the present disclosure;

FIG. 13 is a perspective view illustrating a passenger safety device according to an embodiment of the present disclosure;

FIG. 14 is a perspective view illustrating a passenger safety device according to an embodiment of the present disclosure;

FIG. 15 is a perspective view illustrating a passenger safety device according to an embodiment of the present disclosure;

FIG. 16 is a perspective view illustrating a passenger safety device according to an embodiment of the present disclosure;

FIG. 17 is a perspective view illustrating a passenger safety device according to an embodiment of the present disclosure; and

FIG. 18 is a perspective view illustrating a passenger safety device according to an embodiment of the present disclosure.

### DETAILED DESCRIPTION OF ILLUSTRATIVE EMBODIMENTS

While an embodiment of the present disclosure may be modified in various ways and take on various alternative forms, specific example embodiments are shown in the drawings and described in detail below. However, it can be understood that there is no intent to necessarily limit the present disclosure to the particular forms disclosed, but on the contrary, the present disclosure can cover modifications, equivalents, and alternatives for embodiments falling within the spirit and scopes of the present disclosure.

It can be understood that, although the terms “first,” “second,” etc. may be used herein to describe various elements, these elements should not be necessarily limited by these terms. These terms can be used merely to distinguish one element from another. For example, a first element could be termed a second element, and a second element could similarly be termed a first element without departing from the scopes of the present disclosure. As used herein, the term “and/or” includes any and all combinations of one or more of the associated listed items.

The terms, such as “unit, part, portion, etc.” may be used to describe various components, but the components should not be necessarily limited by these terms. The terms may refer to not only physically/visually distinct components, but also or alternatively can refer to functions or components of a portion even if the corresponding portion is not clearly divided.

The terms used herein to describe example embodiments of the present disclosure are not intended to necessarily limit the scopes of the present disclosure. The articles “a,” and “an” are singular in that they have a single referent, however the use of the singular form in the present document should not preclude the presence of more than one referent. In other words, elements of the present disclosure referred to in the singular may number one or more, unless the context clearly indicates otherwise. It will be further understood that the terms “comprise,” “comprising,” “include,” and/or “including,” when used herein, specify the presence of stated features, numbers, steps, operations, elements, and/or components but do not preclude the presence or addition of one or more other features, numbers, steps, operations, elements, components, and/or groups thereof.

Unless defined in a different way, terms used herein, including technical and scientific terms, can have same meanings as understood by those skilled in the art to which the present disclosure pertains. Such terms as defined in generally used dictionaries should be construed to have the same meanings as those of the contexts of the related art, and unless clearly defined in the application, they should not be construed to have ideally or excessively formal meanings.

In the description below, the terms “anterior,” “posterior,” “lateral,” “front,” “rear,” “up/down,” “above,” “upper,” “top,” “below,” “lower,” “bottom,” “left/right” and the like can be defined based on a vehicle or vehicle body. In addition, terms, such as “first” and “second” may be used to describe various components, but these components are not necessarily limited in order, size, position, or importance by such terms, such as first and second and named for the sole purpose of distinguishing one component from another.

Hereinafter, example embodiments of the present disclosure will be described with reference to the accompanying drawings.

In the diagrams, D1 may be referred to as a first direction, D2, intersecting the first direction D1, may be referred to as a second direction, and D3, intersecting each of the first direction D1 and the second direction D2, may be referred to as a third direction. The first direction D1 may be referred to as an upward direction, and the direction opposite to the first direction D1 may be referred to as a downward direction. In addition, each of the second direction D2 and the third direction D3 may be referred to as a horizontal direction.

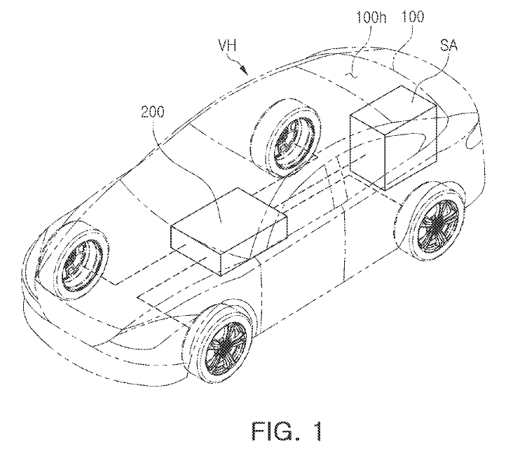

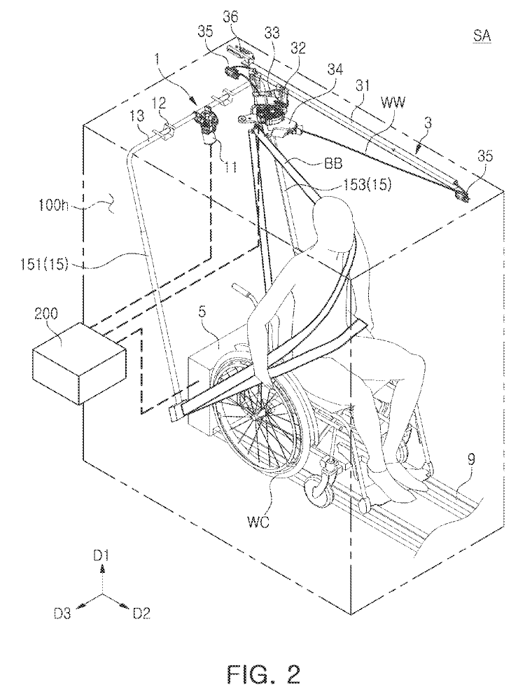

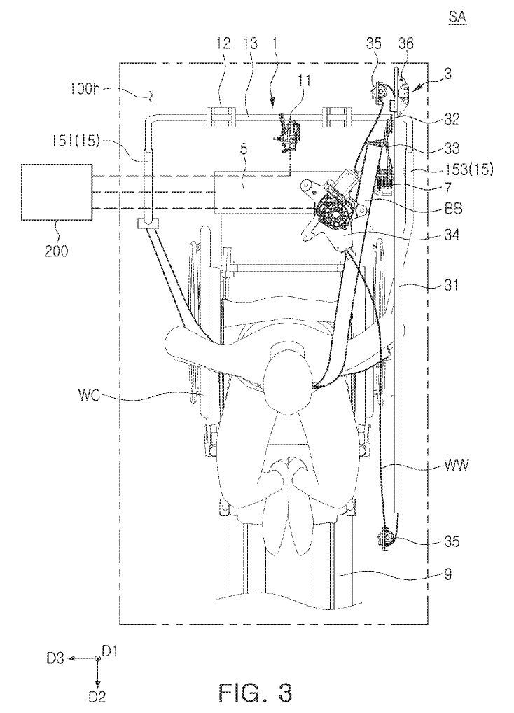

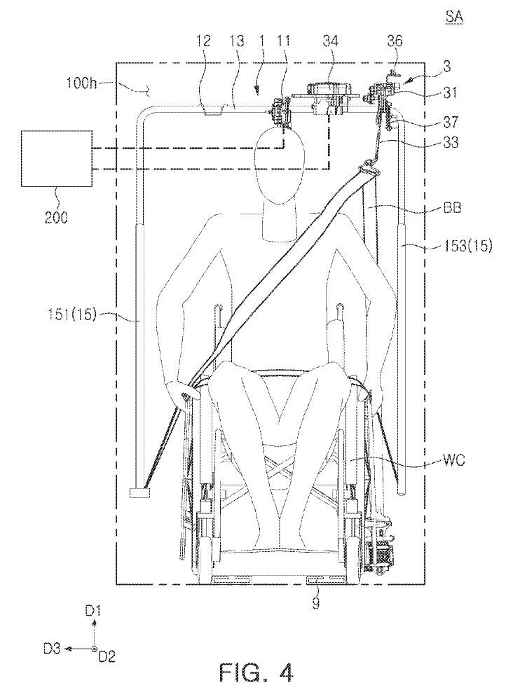

FIG. 1 is a perspective view schematically illustrating a vehicle VH according to an embodiment of the present disclosure. FIG. 2 is a perspective view illustrating a controller 200, a passenger in a wheelchair WC, and a passenger safety device SA according to an embodiment of the present disclosure. FIG. 3 is a top view illustrating the controller 200, the passenger in the wheelchair WC, and the passenger safety device SA according to an embodiment of the present disclosure. FIG. 4 is a front view illustrating the controller 200, the passenger in a wheelchair WC, and the passenger safety device SA according to an embodiment of the present disclosure.

Referring to FIG. 1, the vehicle VH may include a vehicle body 100, a passenger safety device SA, and a controller 200. The vehicle VH may refer to a passenger vehicle but is not limited thereto. The vehicle VH may refer to any system of transportation that a disabled person in a wheelchair may board. The vehicle body 100 may refer to the body of a system of transportation that a disabled person may board. The vehicle body 100 may have an internal space 100h in which a passenger may board and a passenger safety device SA may be located. The controller 200 may be connected to the passenger safety device SA and control the passenger safety device SA.

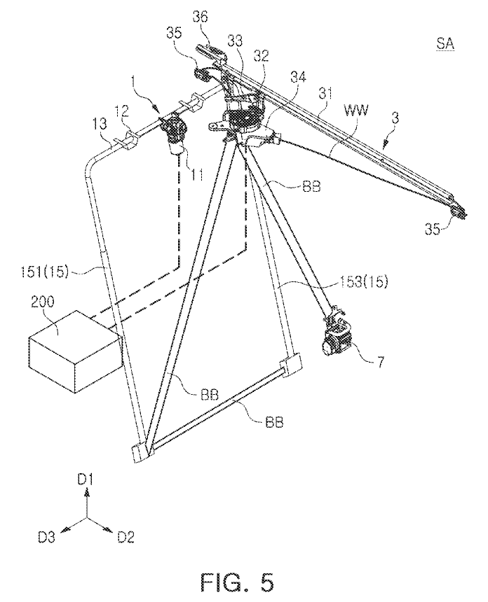

Referring to FIGS. 2, 3, and 4, the passenger in a wheelchair WC can be in the internal space 100h and the passenger can be secured by the passenger safety device SA. Hereinafter, in this specification, a passenger may refer to the same person as an occupant, and passenger and occupant may be used interchangeably. Hereinafter, in FIG. 5 and the subsequent drawings, the internal space 100h may not be illustrated for convenience, but the passenger safety device SA can be assumed to be located in the internal space 100h. The passenger safety device SA may be coupled to and supported in the vehicle body 100 defining the internal space 100h.

The controller 200 according to an embodiment may be connected to various components of the passenger safety device SA and control the passenger safety device SA. The controller 200 may include a microcontroller, a microprocessor, etc. that process various signals and execute commands. The controller 200 may include a voltage regulator, a battery, etc. that may supply power to drive the passenger safety device SA. However, the configuration of the controller 200 is not necessarily limited thereto and may further include various components that may control the passenger safety device SA.

The controller 200 may be coupled to the vehicle body 100. The controller 200 may be located inside the vehicle body 100. The controller 200 may be located in any space of the vehicle VH. In this specification, the controller 200 may be illustrated as being located outside the internal space 100h but is not limited thereto.

The passenger safety device SA according to an embodiment may include a first restraint device 1, a second restraint device 3, a wheelchair docking device 5, and a belt BB. The passenger safety device SA according to an embodiment may optionally or selectively include a retractor 7 and a floor rail 9.

The first restraint device 1 may be located in the internal space 100h. The first restraint device 1 may support the belt BB. One side of the first restraint device 1 may be connected to the belt BB. The other side of the first restraint device 1 located opposite to one side of the first restraint device 1 may be connected to the belt BB. The first restraint device 1 may be rotatable. The passenger in the wheelchair WC by use of the first restraint device 1 may have his/her abdomen and waist supported by the belt BB. The first restraint device 1 may fix the passenger by the belt BB while rotating. This will be described below.

The first restraint device 1 according to an embodiment may include a rotary motor 11, a rotary arm 13, and a support arm 15. The support arm 15 may include a first support arm 151 and a second support arm 153. The first restraint device 1 according to an embodiment may selectively include a rotary arm bracket 12. The rotary arm bracket 12 may be coupled to the vehicle body 100. The configuration of an example first restraint device 1 will be described below.

The second restraint device 3 may be located in the internal space 100h. The second restraint device 3 may support the belt BB. The second restraint device 3 may be connected to the first restraint device 1 by the belt BB. The second restraint device 3 according to an embodiment may include a roller rail 31, a roller 32, and a belt support portion 33. The second restraint device 3 according to an embodiment may selectively include a wire WW, a wire motor 34, a stopper 36, a latch 37, and a wire guide 35. The roller rail 31, the wire motor 34, the stopper 36, the latch 37, and the wire guide 35 according to an embodiment may be coupled to the vehicle body 100. The roller rail 31, the wire motor 34, the stopper 36, the latch 37, and the wire guide 35 according to an embodiment may be supported by the vehicle body 100. However, the coupling relationship and position of the second restraint device 3 are not limited thereto.

The second restraint device 3 may support the belt BB by the belt support portion 33. The belt support portion 33 may move. More specifically, the belt support portion 33 may move from a forward direction of the passenger to a backward direction. The belt support portion 33 may move from the backward direction of the passenger to the forward direction. In this specification, the direction from the floor to the top of the passenger's head may be referred to as the first direction D1. In this specification, the direction toward the front of the passenger may be referred to as the second direction D2. The second direction D2 may be referred to as the forward direction. The direction opposite to the second direction D2 may be referred to as the backward direction. The first direction D1 and the second direction D2 may be perpendicular to each other.

The belt support portion 33 may move in the second direction D2 or the opposite direction of the second direction D2 by the roller 32. Accordingly, the belt support portion 33 may not interfere with the passenger when the passenger boards or exits.

Other components of the second restraint device 3 will be described below.

The wheelchair docking device 5 may be located in the internal space 100h. The wheelchair docking device 5 may be coupled to the vehicle body 100. The wheelchair docking device 5 may support the wheelchair WC. The wheelchair docking device 5 may move the wheelchair WC. More specifically, the wheelchair docking device 5 may move on the floor rail 9 and move the wheelchair WC. The floor rail 9 can be located in the internal space 100h and may be coupled to the vehicle body 100. The wheelchair WC may be fixed by the wheelchair docking device 5. The wheelchair docking device 5 will be described below.

The retractor 7 may support the belt BB. The retractor 7 may store the belt BB. The belt BB may be stored inside the retractor 7 and then released out of the retractor 7. The belt BB, which has been present outside the retractor 7, may enter the retractor 7 to be stored.

The retractor 7 may be located in the internal space 100h and may be coupled to the vehicle body 100. The retractor 7 may be located on the side of the wheelchair docking device 5. The retractor 7 may be located on the side of the floor rail 9. However, the position of the retractor 7 is not limited thereto and may be located in any position in the internal space 100h.

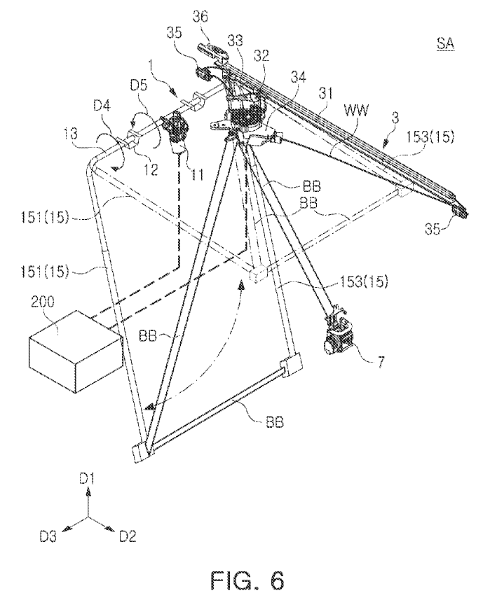

FIG. 5 is a perspective view illustrating the controller 200, the first restraint device 1, and the second restraint device 3 according to an embodiment of the present disclosure. FIG. 6 is a perspective view illustrating the controller 200 and the moving first restraint device 1 and the second restraint device 3 according to an embodiment of the present disclosure.

The first restraint device 1 according to an embodiment may include the rotary motor 11, the rotary arm 13, and the support arm 15. The support arm 15 may include the first support arm 151 and the second support arm 153. The first restraint device 1 according to an embodiment may selectively include the rotary arm bracket 12.

The rotary arm bracket 12 may be coupled to the vehicle body 100. The rotary arm bracket 12 may support the rotary arm 13. The rotary arm bracket 12 may be provided in plural, but the present disclosure is not limited thereto. Hereinafter, a plurality of rotary arm brackets 12 may be treated to be described as a single rotary arm bracket.

Referring to FIG. 6, the rotary arm 13 may be coupled to the rotary motor 11. The controller 200 may be connected to the rotary motor 11. The controller 200 may rotate the rotary arm 13 with the rotary motor 11. The rotary motor 11 may rotate the rotary arm 13 clockwise D4 or counterclockwise D5. The rotary arm 13 may have a rod shape. However, the shape of the rotary arm 13 is not limited thereto.

The rotary arm 13 may be connected to the support arm 15. The support arm 15 may include a first support arm 151 and a second support arm 153. One side of the rotary arm 13 may be connected to one side of the first support arm 151. The other side of the rotary arm 13 may be connected to one side of the second support arm 153. The support arm 15 may support the belt BB. More specifically, the other side of the first support arm 151 located opposite to one side of the first support arm 151 may support the belt BB. The other side of the second support arm 153 located opposite to one side of the second support arm 153 may support the belt BB. The first support arm 151 and the second support arm 153 may be connected by the belt BB.

Referring to FIG. 6, the support arm 15 may also rotate when the rotary motor 11 rotates the rotary arm 13. The controller 200 may rotate the support arm 15 using the rotary motor 11. When the rotary arm 13 rotates clockwise D4 by the rotary motor 11, the support arm 15 may be lowered. When the rotary arm 13 rotates clockwise D4, a first side of the first support arm 151 connected to the belt BB and a second side of the second support arm 153 may also rotate clockwise D4 to be lowered. When the rotary arm 13 rotates counterclockwise D5 by the rotary motor 11, the support arm 15 may be raised. When the rotary arm 13 rotates counterclockwise D5, the first side of the first support arm 151 connected to the belt BB and the second side of the second support arm 153 may also rotate counterclockwise D5 to be raised.

Referring to FIG. 6, the length of the support arm 15 may be variable. The controller 200 may change the length of the support arm 15. In this specification, the support arm 15 may become shorter when raised and may become longer when lowered but is not limited thereto. The support arm 15 may become longer when raised and may be shorter when lowered. The length of the support arm 15 may vary as required or desired for a given situation or design.

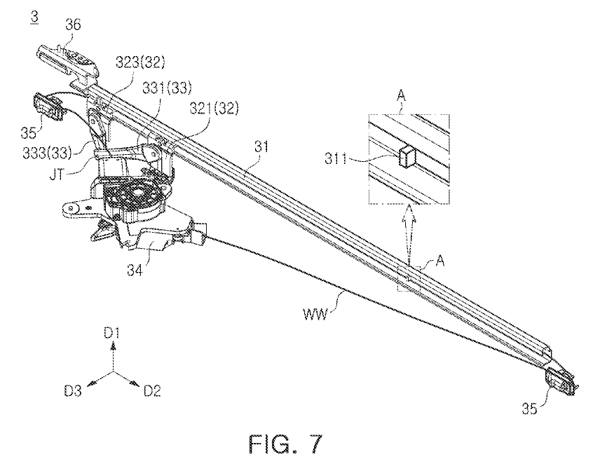

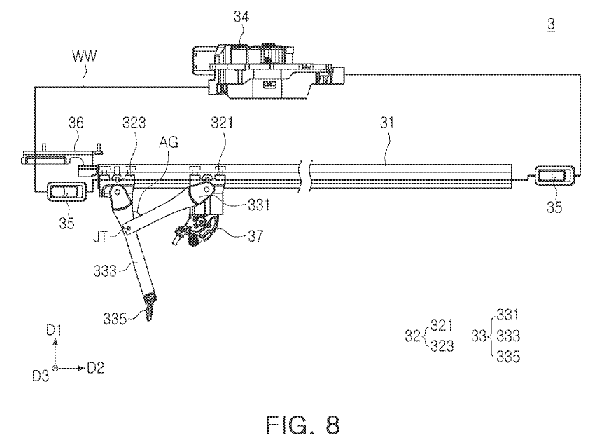

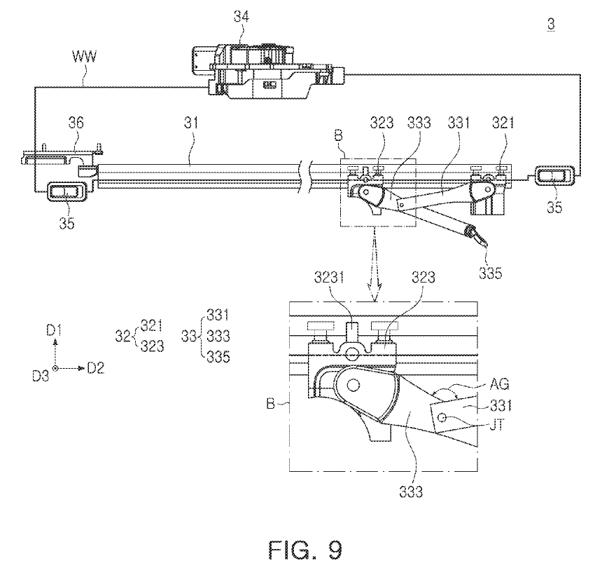

FIG. 7 is a side view illustrating a second restraint device 3 according to an embodiment of the present disclosure. FIG. 8 is a side view illustrating a second restraint device 3 according to an embodiment of the present disclosure. FIG. 9 is a side view illustrating a second restraint device 3 according to an embodiment of the present disclosure.

Referring to FIGS. 6 and 7, the second restraint device 3 according to an embodiment may include the roller rail 31, the roller 32, and the belt support portion 33. The second restraint device 3 according to an embodiment may selectively include the wire WW, the wire motor 34, the wire guide 35, the stopper 36, and the latch 37. The roller rail 31, the stopper 36, the latch 37, the wire motor 34, and the wire guide 35 may be coupled to the vehicle body 100 and supported by the vehicle body 100. However, the positions of the components are not limited thereto.

Referring to FIGS. 6 and 7, the roller rail 31 may be located on the first restraint device 1. A level of the roller rail 31 may be higher than a level of the rotary arm 13. The roller rail 31 may extend in the second direction D2. Referring to the enlarged view of region A, the roller rail 31 may include a roller coupling portion 311. The roller coupling portion 311 may have a shape protruding from the roller rail 31 but is not limited thereto. The movement of the roller 32 on the roller rail 31 may be restricted by the roller coupling portion 311. This will be described below.

Referring to FIGS. 6, 7, 8, and 9, the controller 200 may be connected to the wire motor 34. The controller 200 may move the wire WW by the wire motor 34. The wire motor 34 may be coupled to the vehicle body 100 but is not limited thereto. The wire WW may pass through the wire motor 34. The wire WW may be supported by the roller rail 31. The wire WW may move along the roller rail 31. The wire WW may move along the roller rail 31 by the wire guide 35. The wire guide 35 may guide the wire WW. The wire guide 35 may be provided in plural. The plurality of wire guides 35 may be treated to be described as a single wire guide. The wire motor 34 may control the wire WW so that the wire WW may move forward or backward on the roller rail 31.

Referring to FIGS. 7, 8, and 9, the roller 32 may be coupled to the roller rail 31. The roller 32 may move along the roller rail 31. The roller 32 may include a first roller 321 and a second roller 323. The first roller 321 may be located in front of the second roller 323. The first roller 321 may be located in a position further moved in the second direction D2 than the second roller 323.

The controller 200 may move the roller 32 using the wire motor 34. The roller 32 may be moved by the wire WW. The roller 32 may be coupled to the wire WW. When the wire motor 34 moves the wire WW in the second direction D2, the roller 32 may also move in the second direction D2. When the wire motor 34 moves the wire WW in the opposite direction of the second direction D2, the roller 32 may also move in the opposite direction of the second direction D2.

Referring to FIGS. 7, 8, and 9, the belt support portion 33 may include a first belt support arm 331, a second belt support arm 333, and a belt ring 335. The first belt support arm 331 may be connected to the first roller 321. The second belt support arm 333 may be connected to the second roller 323.

The first belt support arm 331 and the second belt support arm 333 may be connected by a joint JT whose angle may be adjusted. The joint JT may change a support arm angle AG formed by the first belt support arm 331 and the second belt support arm 333. The support arm angle AG can be limited due to the joint JT. For example, referring to FIG. 8, the support arm angle AG when the first roller 321 and the second roller 323 have been moved to the rearmost may be the minimum angle formed by the first belt support arm 331 and the second belt support arm 333.

The second belt support arm 333 may be connected to the belt ring 335. The belt ring 335 may have a ring shape. However, the shape of the belt ring 335 is not limited thereto. The belt BB may pass through the belt ring 335. The belt ring 335 may support the belt BB. Referring to FIGS. 6 and 7, the belt BB released from the retractor 7 may extend through the belt ring 335 of the belt support portion 33 and the first support arm 151 to the second support arm 153.

Referring to FIG. 8, the second restraint device 3 may be provided when the roller 32 is located at the rearmost position. The roller 32 may be located at the rearmost position on the roller rail 31 when securing the passenger but is not limited thereto. The second roller 323 may be restricted from moving further backward on the roller rail 31 by the stopper 36. The stopper 36 may prevent the second roller 323 from moving out of the roller rail 31. If the movement of the second roller 323 is restricted by the stopper 36, the first roller 321 may not move further backward due to the angle restriction by the joint JT.

The latch 37 may be coupled to the first roller 321. The latch 37 may be coupled to the vehicle body 100 and supported by the vehicle body 100. The movement of the first roller 321 may be restricted by the latch 37. The roller may be fixed by the latch 37 and the stopper 36.

Referring to FIG. 9, the second restraint device 3 may be provided when the roller 32 has moved forward. As the wire WW is moved by the wire motor 34, the roller 32 may also move forward. Referring to an enlarged view B of FIG. 9, the second roller 323 may include a rail coupling portion 3231. The second roller 323 may be engaged with the roller coupling portion 311 by the rail coupling portion 3231 to be restricted from moving on the roller rail 31. The forward movement of the second roller 323 may be restricted by the rail coupling portion 3231. As the first roller 321 moves forward while the movement of the second roller 323 is restricted, the support arm angle AG between the first belt support arm 331 and the second belt support arm 333 may increase. Referring to FIG. 9, when the first roller 321 and the second roller 323 moves to the frontmost on the roller rail 31, the support arm angle AG may be maximized. As the support arm angle AG increases, the belt ring 335 may also move upward.

The joint JT may include a spring. As the support arm angle AG increases, elasticity of the spring of the joint JT may increase. As the support arm angle AG increases, force to reduce the support arm angle AG may become stronger. As the belt ring 335 moves upward, interference of the belt ring 335 may be reduced when the passenger boards or exits the vehicle.

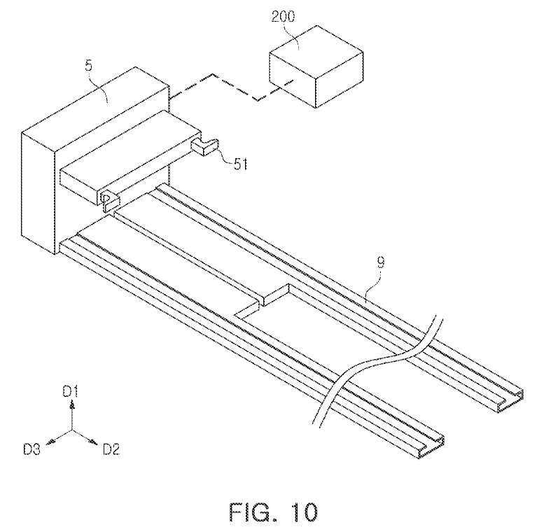

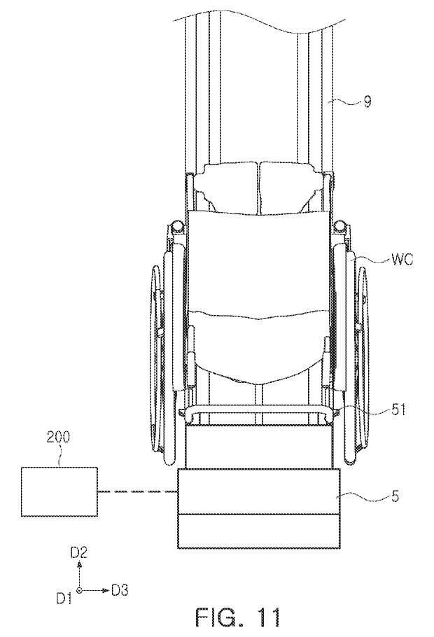

FIG. 10 is a perspective view illustrating the controller 200, the floor rail 9, and the wheelchair docking device 5 according to an embodiment of the present disclosure. FIG. 11 is a top view illustrating the controller 200, the floor rail 9, and the wheelchair docking device 5 according to an embodiment of the present disclosure.

Referring to FIGS. 10 and 11, the floor rail 9 may be located in the internal space 100h and may be coupled to the vehicle body 100. In an embodiment of the present specification, the floor rail 9 may extend in the second direction D2. The extension direction of the floor rail 9 may be the same as an extension direction of the roller rail 31 but is not limited thereto. The wheelchair docking device 5 may be located on the floor rail 9. The wheelchair docking device 5 may move along the floor rail 9. The controller 200 may be connected to the wheelchair docking device 5. The wheelchair docking device 5 may be moved on the floor rail 9 by the controller 200. As the wheelchair docking device 5 moves, the wheelchair docking device 5 may support boarding or exciting of the passenger.

The wheelchair docking device 5 may fix the wheelchair WC. The wheelchair WC may be fixed by the wheelchair docking device 5, thereby increasing the safety of the passenger. The wheelchair WC may be located in a correct position by the wheelchair docking device 5. The position dispersion of the passenger may be reduced when the belt BB is fastened by the wheelchair docking device 5. The wheelchair docking device 5 may be located below the first restraint device 1 and the second restraint device 3.

Referring to FIGS. 10 and 11, the wheelchair docking device 5 may include at least one wheelchair fixing hook 51. The wheelchair fixing hook 51 may have a hook shape but is not limited thereto. The wheelchair fixing hook 51 may further include various shapes that may connect the wheelchair WC to the wheelchair docking device 5. The length of the wheelchair fixing hook 51 may vary. The wheelchair fixing hook 51 may extend to connect the wheelchair WC to the wheelchair docking device 5.

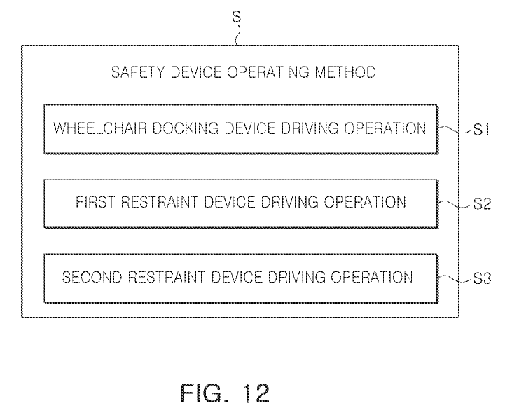

FIG. 12 is a flowchart illustrating a safety device operating method S according to an embodiment of the present disclosure.

Referring to FIG. 12, the safety device operating method S may include a wheelchair docking device driving operation S1, a first restraint device driving operation S2, and a second restraint device driving operation S3.

The wheelchair docking device driving operation S1 may be an operation of coupling the wheelchair docking device 5 to the wheelchair WC and moving the wheelchair WC. The first restraint device driving operation S2 may be an operation of rotating the first restraint device 1. The second restraint device driving operation S3 may be an operation of moving the second restraint device 3 to move the belt support portion 33. Hereinafter, the safety device operating method S will be described with reference to FIGS. 12 to 17.

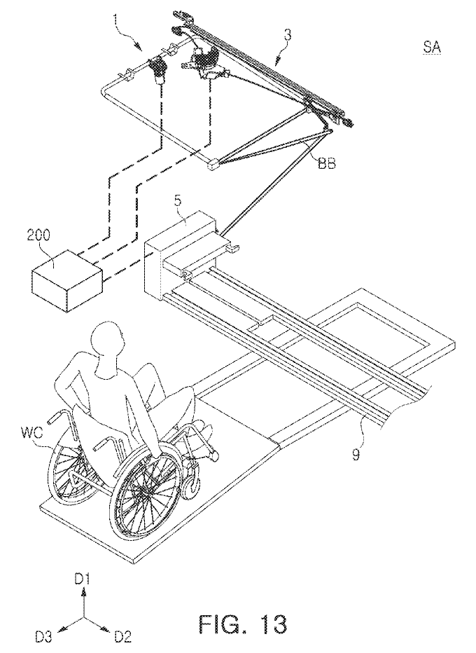

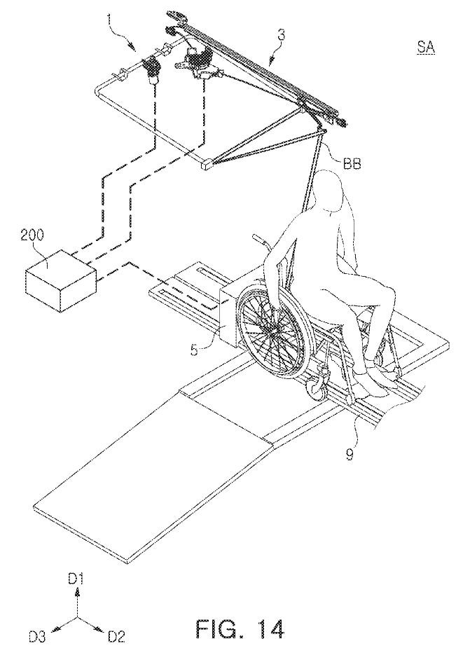

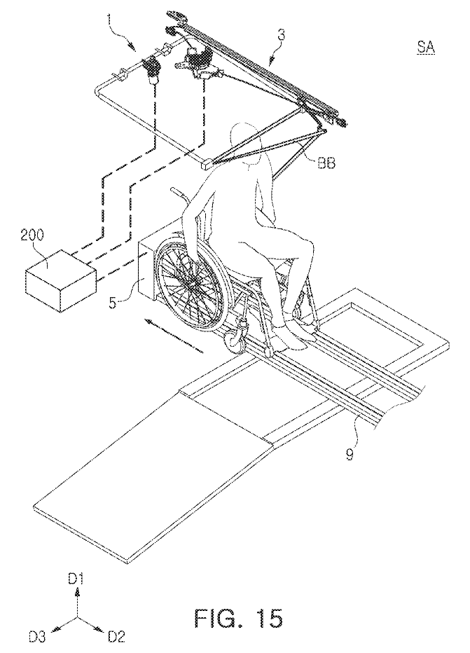

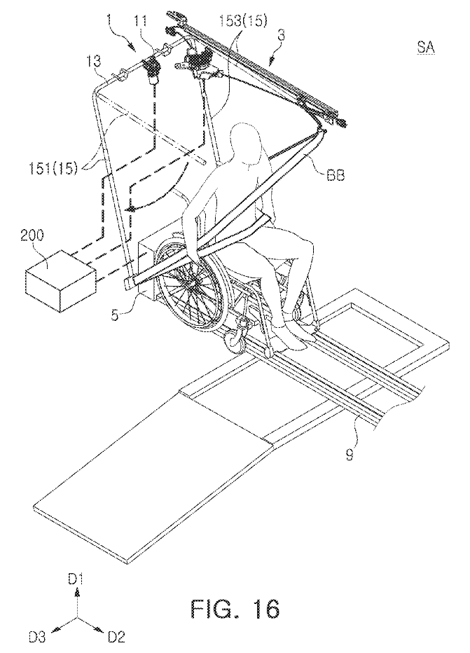

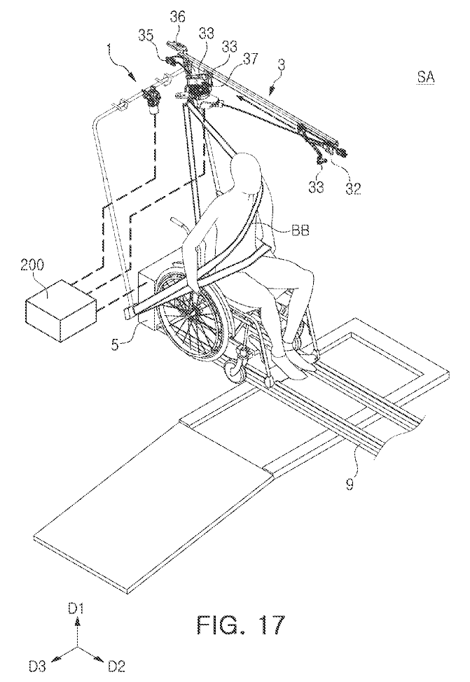

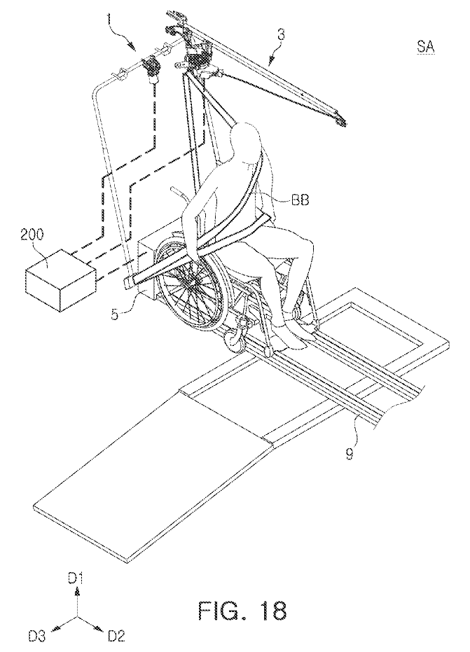

FIG. 13 is a perspective view illustrating the controller 200 and the passenger safety device SA according to an embodiment of the present disclosure. FIG. 14 is a perspective view illustrating the controller 200 and the passenger safety device SA according to an embodiment of the present disclosure. FIG. 15 is a perspective view illustrating the controller 200 and the passenger safety device SA according to an embodiment of the present disclosure. FIG. 16 is a perspective view illustrating the controller 200 and the passenger safety device SA according to an embodiment of the present disclosure. FIG. 17 is a perspective view illustrating the controller 200 and the passenger safety device SA according to an embodiment of the present disclosure. FIG. 18 is a perspective view illustrating the controller 200 and the passenger safety device SA according to an embodiment of the present disclosure. The method S of FIG. 12 and an illustrative use of the passenger safety device SA are illustrated in FIGS. 13-18

Referring to FIG. 13, the passenger may move the wheelchair WC to the floor rail 9. Referring to FIG. 14, the controller 200 may move the wheelchair docking device 5 forward to connect the wheelchair WC to the wheelchair docking device 5. The wheelchair WC may be supported by the wheelchair docking device 5. Referring to FIG. 15, the controller 200 may move the wheelchair docking device 5 backward along the floor rail 9 to position the wheelchair WC in a correct position. The wheelchair WC may be located in a correct position by the wheelchair docking device 5. The wheelchair docking device driving operation S1 may include connecting the wheelchair docking device 5 to the wheelchair WC and positioning the wheelchair WC in a correct position by the wheelchair docking device 5. The wheelchair docking device 5 may be controlled by the controller 200 to move and support the wheelchair WC.

Referring to FIG. 16, the controller 200 may lower the support arm 15 by rotating the first restraint device 1. As the support arm 15 rotates to be lowered, the belt BB located between the first support arm 151 and the second support arm 153 may support the waist and abdomen of the passenger. The first side of the first support arm 151 and the second side of the second support arm 153 supporting the belt BB may be located on both sides of the wheelchair docking device 5. When the first support arm 151 and the second support arm 153 are lowered, the lengths of the first support arm 151 and the second support arm 153 may increase. However, the change in the length of the support arm 15 is not limited thereto. The first restraint device driving operation S2 may include rotating the rotary arm 13 to position the support arm 15 next to the wheelchair docking device 5. The first restraint device driving operation S2 may include changing the length of the support arm 15. The controller 200 may control the first restraint device 1 to change the length of the support arm 15 and rotate the rotary arm 13.

Referring to FIG. 17, the controller 200 may move the belt support portion 33 of the second restraint device 3. The controller 200 may control the wire motor 34 to move the roller 32 and the belt support portion 33. The second restraint device driving operation S3 may include driving the second restraint device 3 to move the belt support portion 33 and the roller 32 backward. Referring to FIG. 18, after the roller 32 moves to the rearmost position, the movement of the roller 32 may be restricted and the roller may be fixed by the stopper 36 and the latch 37. The second restraint device driving operation may include fixing the roller by the latch 37. When the support arm 15 of the first restraint device 1 is lowered and the roller 32 and the belt support portion 33 of the second fixing device 3 are moved to the rear and fixed, the passenger's position can be secured and the passenger may be safely supported.

FIGS. 13 to 18 illustrate the passenger being secured by the passenger safety device SA, but the order of the wheelchair docking device driving operation S1, the first restraint device driving operation S2, and the second restraint device driving operation S3 is not limited. The first restraint device driving operation S2 and the second restraint device driving operation S3 may be performed simultaneously. However, the order of the first restraint device driving operation S2 and the second restraint device driving operation S3 is not limited thereto, and the first restraint device driving operation S2 may precede the second restraint device driving operation S3. The first restraint device driving operation S2 may follow the second restraint device driving operation S3.

Although FIGS. 13 to 18 illustrate the passenger who boards, the passenger may exit by performing the method in reverse order. The controller 200 may raise the first restraint device 1 upward and move the roller 32 and the belt support portion 33 of the second restraint device 3 forward. The first restraint device driving operation S2 may include lifting the support arm 15 upward by the rotary motor 11. The second restraint device driving operation S3 may include moving the roller 32 and the belt support portion 33 forward. The controller 200 may move the wheelchair WC forward by moving the wheelchair docking device 5 forward. The passenger may move along the floor rail 9 by the wheelchair docking device 5 and then exit. The wheelchair docking device driving operation S1 may include moving the wheelchair WC forward by the wheelchair docking device 5.

According to the passenger safety device SA, the vehicle VH including the same, and the safety device operating method S using the same according to an embodiment of the present disclosure, the belt BB may not interfere with the passenger when the passenger boards or exits the vehicle VH. When the passenger boards or exits, the controller 200 may prevent the belt BB from interfering with the passenger by driving the first restraint device 1 and the second restraint device 3, or may ease entry and exit for the passenger with relation to the passenger safety device SA. The controller 200 may drive the rotary motor 11 to move the support arm 15 upward, thereby causing the belt BB to be separated from the direction of movement of the passenger. The controller 200 may drive the wire motor 34 to move the roller 32 and the belt support portion 33 forward, thereby causing the belt BB to be separated from the direction of movement of the passenger. As the controller 200 controls the first restraint device 1 and the second restraint device 3, the degree of freedom of movement of the passenger may increase.

According to the passenger safety device SA, the vehicle VH including the same, and the safety device operating method S using the same according to an embodiment of the present disclosure, the passenger safety device SA may support the passenger and the wheelchair according to a body shape of the passenger. According to an embodiment of the present disclosure, the length of the rotary arm 13 may be longer than the width of the wheelchair WC and the passenger. A distance between the support arms 15 may be greater than the width of the wheelchair WC and the passenger. The first restraint device 1 may surround the wheelchair WC and the passenger. The level of the second restraint device 3 may be higher than the level of the wheelchair WC. The driving of the first restraint device 1 and the second restraint device 3 may be unaffected by the wheelchair WC and the body shape of the passenger.

According to the passenger safety device SA, the vehicle VH including the same, and the safety device operating method S using the same according to an embodiment of the present disclosure, the space utilization of the vehicle may increase. The wheelchair docking device 5 may be located at the rear of the wheelchair WC. Because the wheelchair docking device 5 can be located at the rear of the wheelchair WC rather than at the side of the wheelchair WC, the utilization of the space next to the wheelchair WC may increase, which can be a desirable advantage.

According to the passenger safety device SA, the vehicle VH including the same, and the safety device operating method S using the same according to an embodiment of the present disclosure, the passenger safety may increase. The wheelchair docking device 5 may be coupled to the wheelchair WC to fix the wheelchair WC to a specific position. The passenger and the wheelchair WC may be secured to a specific position by the first restraint device 1 and the second restraint device 3. The wheelchair WC and the passenger can be secured by the first restraint device 1, the second restraint device 3, and the wheelchair docking device 5, so that the safety of the passenger may increase.

While example embodiments have been shown and described above, it can be apparent to those skilled in the art that modifications and variations can be made without departing from the scopes of the present disclosure as defined by the appended claims.

What is claimed is:

1. A passenger safety device comprising:
a belt;
a first restraint device being rotatable and having a first side and a second side connected to the belt; and
a second restraint device connected to the first restraint device by the belt, wherein the second restraint device includes:
a roller rail,
a roller connected to the roller rail and being drivable on the roller rail, and
a belt support portion connected to the roller and configured to support the belt.

2. The passenger safety device of claim 1, wherein the first restraint device comprises:
a rotary motor;
a rotary arm connected to the rotary motor;
a first support arm connected to a first rotary-arm side of the rotary arm; and
a second support arm connected to a second rotary-arm side of the rotary arm.

3. The passenger safety device of claim 2, wherein the first support arm and the second support arm are connected by the belt.

4. The passenger safety device of claim 2, wherein the first support arm and the second support arm are configured to vary in length.

5. The passenger safety device of claim 2, further comprising a retractor located below the first restraint device and the second restraint device, wherein the retractor is configured to adjust a belt length of the belt, and wherein the belt extends from the retractor and passes through the belt support portion and the first support arm to the second support arm.

6. The passenger safety device of claim 1, wherein the roller includes a first roller and a second roller located behind the first roller, and wherein the belt support portion comprises:
a first belt support arm connected to the first roller;
a second belt support arm connected to the second roller; and
a belt ring connected to the second belt support arm and supporting the belt.

7. The passenger safety device of claim 1, wherein the second restraint device further comprises:
a roller wire connected to the roller and supported by the roller rail; and
a wire motor configured to move the roller wire.

8. The passenger safety device of claim 6, wherein the second restraint device further comprises a stopper located on the first restraint device and configured to restrict movement of the second roller.

9. The passenger safety device of claim 6, wherein the first belt support arm and the second belt support arm are connected by a joint, and wherein the joint is kinematically configured to control a support arm angle between the first belt support arm and the second belt support arm.

10. The passenger safety device of claim 6, wherein the second roller comprises a rail coupling portion coupled to the roller rail, and wherein movement of the second roller is restricted on the roller rail by the rail coupling portion.

11. The passenger safety device of claim 6, wherein the second restraint device further comprises a latch coupled to the first roller and configured to restrict movement of the first roller.

12. The passenger safety device of claim 1, further comprising:
a floor rail; and
a wheelchair docking device located below the first restraint device and the second restraint device, wherein the wheelchair docking device is movably coupled on the floor rail.

13. The passenger safety device of claim 12, wherein the wheelchair docking device comprises a hook-shaped wheelchair fixing hook.

14. A method of operating a passenger safety device, the method comprising:
a wheelchair docking device driving operation of coupling, by a controller, a wheelchair docking device to a wheelchair and moving, by the controller, the wheelchair by the wheelchair docking device;
a first restraint device driving operation of rotating, by the controller, a first restraint device; and
a second restraint device driving operation of moving, by the controller, a belt support portion of a second restraint device, wherein, in the second restraint device driving operation, the controller controls movement of the belt support portion by moving a roller connected to a wire by a wire motor.

15. The method of claim 14, wherein the first restraint device driving operation and the second restraint device driving operation are performed simultaneously.

16. The method of claim 14, wherein, in the second restraint device driving operation, a position of a first roller portion of the roller is fixed by coupling a latch to the first roller portion.

17. A passenger safety device comprising:
a belt;
a first restraint device being rotatable and having a first side and a second side connected to the belt, wherein the first restraint device includes:
a rotary motor,
a rotary arm connected to the rotary motor,
a first support arm connected to a first rotary-arm side of the rotary arm, and
a second support arm connected to a second rotary-arm side of the rotary arm, wherein the first support arm and the second support arm are connected by the belt;
a second restraint device connected to the first restraint device by the belt, wherein the second restraint device includes:
a roller rail,
a roller connected to the roller rail and being drivable on the roller rail, and
a belt support portion connected to the roller and configured to support the belt; and
a retractor located below the first restraint device and the second restraint device, wherein the retractor is configured to adjust a belt length of the belt, and wherein the belt extends from the retractor and passes through the belt support portion and the first support arm to the second support arm.

18. The passenger safety device of claim 17, wherein the roller includes a first roller and a second roller located behind the first roller;
wherein the belt support portion comprises:
a first belt support arm connected to the first roller,
a second belt support arm connected to the second roller, and
a belt ring connected to the second belt support arm and supporting the belt;
wherein the second restraint device further comprises:
a roller wire connected to the roller and supported by the roller rail,
a wire motor configured to move the roller wire, and
a stopper located on the first restraint device and configured to restrict movement of the second roller; and
wherein the first belt support arm and the second belt support arm are connected by a joint, and wherein the joint is kinematically configured to control a support arm angle between the first belt support arm and the second belt support arm.

19. The passenger safety device of claim 18, wherein the second roller comprises a rail coupling portion coupled to the roller rail, and wherein movement of the second roller is restricted on the roller rail by the rail coupling portion;
wherein the second restraint device further comprises a latch coupled to the first roller and configured to restrict movement of the first roller; and
wherein the first support arm and the second support arm are configured to vary in length.

20. The passenger safety device of claim 17, further comprising:
a floor rail; and
a wheelchair docking device located below the first restraint device and the second restraint device, wherein the wheelchair docking device is movably coupled on the floor rail, wherein the wheelchair docking device comprises a hook-shaped wheelchair fixing hook.
